(19) United States
(12) Patent Application Publication
(10) Pub. No.: US 2009/0119196 A1
(43) Pub. Date: May 7, 2009

(54) METHOD AND A SYSTEM FOR CONCLUDING AN ELECTRONIC COMMERCIAL TRANSACTION BASED ON A CONDITIONAL OFFER

(76) Inventor: Jean Dobey Ourega, Verdun (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/933,528

(22) Filed: Nov. 1, 2007

(51) Int. Cl. G06Q 30/00

(52) U.S. Cl. 705/37

(57) ABSTRACT

There is provided a method for concluding an electronic commercial transaction based on a conditional offer, the method comprising receiving a conditional offer associated with a trading product, said conditional offer being originated from a first trading party; receiving a conditional offer acceptance in response to the conditional offer, where the offer acceptance is conditioned on the satisfaction of at least one condition, the conditional offer acceptance being originated from a second trading party; determining if the at least one condition is satisfied; and concluding or declining the electronic commercial transaction between the first trading party and the second trading party as a function of the determining. There is further provided a system for concluding an electronic commercial transaction based on a conditional offer.

### FIELD OF THE INVENTION

The present invention relates generally to the field of commercial transactions, and more specifically to a method and a system for concluding an electronic commercial transaction based on a conditional offer.

### BACKGROUND OF THE INVENTION

Traditionally, electronic commercial transactions are concluded bases on standard offers carried out by trading parties. Traditionally, a standard offer to purchase an item is carried out by a second buyer desiring to purchase an item disseminated on a mediator's Web site. Once the standard offer is accepted by the seller, the commercial transaction to purchase the given item is automatically concluded between the buyer and the seller. In certain cases, problems arise regarding the shipping of the item after the conclusion of the transaction, for instance, for unavailability of a shipping service to ship the purchased item. This situation creates a problem since the commercial transaction can not be canceled after the concluding and the buyer and the seller stay bound by the transaction, even though the shipment of the item can not be executed.

### SUMMARY OF THE INVENTION

It is therefore an object of the present invention to provide a method and a system for concluding an electronic commercial transaction based on a conditional offer.

As a first aspect of the invention, there is provided a method for concluding an electronic commercial transaction based on a conditional offer, the method comprising:
receiving a conditional offer associated with a trading product related to a first trading party, the conditional offer being originated from a second trading party;
receiving a conditional offer acceptance in response to the conditional offer, where the offer acceptance is conditioned on the satisfaction of at least one condition, the conditional offer acceptance being originated from the first trading party,
determining if the at least one condition is satisfied; and
concluding or declining the electronic commercial transaction between said the trading party and the second trading party as a function of said determining.

The method preferably further comprises receiving a conditional offer to purchase the product and defining the at least one condition.

The method preferably further comprises transmitting the conditional offer to a trading system for consideration, the conditional offer acceptance being transmitted by the trading system, and, after receiving the conditional offer acceptance, receiving data related to the satisfaction of the at least one condition, where the determining is carried out as a function of the received data and the at least one condition.

Preferably, the method is essentially carried out by a mediator server using a computer program stored therein.

The mediator server is preferably adapted to be connected to a network, and the method is preferably carried electronically over the network.

Preferably, the at least one condition is finding a shipping service to ship the product in accordance with defined shipping criteria, the determining consists of determining an availability of a shipping service in accordance with the defined shipping criteria, and the concluding or declining the commercial transaction between the first trading party and the second trading party consists of concluding the commercial transaction to purchase the product if a shipping service in accordance with the defined shipping criteria is available, and declining the commercial transaction if otherwise.

When the electronic commercial transaction is concluded and the shipping service is associated with a given carrier, the method preferably further comprises concluding a shipping transaction between the second trading party and the carrier to ship the product.

The shipping criteria preferably comprise at least one of an identity of a wanted carrier to ship the product and a cost range for shipping the product.

The mediator server preferably comprises a Web site, the method preferably further comprises disseminating on the mediator's Web site a description of the product and providing means for selecting, through the Web site, an option to carry out a conditional offer associated with the product.

As a further aspect of the invention, there is provided an electronic system for concluding a commercial transaction based on a conditional offer, the system comprising:
an offer acceptance receiving module for receiving a conditional offer acceptance associated with a trading product related to a first trading party, where the offer acceptance is conditioned on the satisfaction of at least one condition, the conditional offer acceptance being in response to a conditional offer originated from a second trading party, the conditional offer acceptance being originated from the first trading party;
a condition satisfaction determining module connected to the offer acceptance receiving module, where the condition satisfaction determining module receives the conditional offer acceptance and the at least one condition, receives data related to the satisfaction of the at least one condition, determines as a function of the received data and the at least one condition if the at least one condition is satisfied, and generates a condition satisfaction signal indicating if the at least one condition is satisfied; and
a transaction concluding module connected to the condition satisfaction determining module, where the transaction concluding module receives the conditional offer acceptance and the condition satisfaction signal and concludes or declines the electronic commercial transaction between the first trading party and the second trading party as a function of the received signal.

The system preferably further comprises a conditional offer receiving module comprising an offer receptor for receiving a conditional offer to purchase the product and a condition definer for defining the at least one condition, where the conditional offer receiving module is connected to a trading system for transmitting the conditional offer thereto for consideration and connected to a database for storing the defined at least one condition therein, where the condition satisfaction determining module is connected to the database for receiving the at least one condition, and the offer acceptance receiving module is connected to the trading system for receiving the conditional offer acceptance associated with the conditional offer.

Preferably, the system is essentially provided by a mediator server. Preferably, the mediator server comprises a Web site and is adapted to be connected to a network.

The system preferably further comprises a listing module for receiving a description of the product and disseminating the description on the Web site, the Web site being preferably connected to an applet for selecting an option for carrying out a conditional offer associated with the product.

Preferably, the at least one condition is finding a shipping service to ship the product in accordance with defined shipping criteria, the determining consists of determining an availability of a shipping service in accordance with the defined shipping criteria, and the concluding or declining the commercial transaction consists of concluding the commercial transaction to purchase the product if a shipping service in accordance with the defined shipping criteria is available, and declining the commercial transaction if otherwise.

The system preferably further comprises a shipping transaction concluding module for concluding a shipping transaction between the second trading party and the carrier associated with the shipping service to ship the product when the electronic commercial transaction is concluded between the first and second trading parties.

The shipping criteria preferably comprise at least one of an identity of a wanted carrier to ship the product and a cost range for shipping the product.

### DESCRIPTION OF THE DRAWINGS

These and other features of the invention will now be described with reference to the drawings of preferred embodiments, which are intended to illustrate and not to limit the invention, and in which:

FIG. 1 depicts a flowchart illustrating a method for concluding an electronic commercial transaction based on a conditional offer;

FIG. 2 depicts a flowchart illustrating a particular case of concluding an electronic commercial transaction based on a conditional offer, where the condition is related to finding an available shipping service in accordance with defined shipping criteria; and

FIG. 3 depicts a bloc diagram illustrating a system for concluding an electronic commercial transaction based on a conditional offer.

### PREFERRED EMBODIMENT OF THE INVENTION

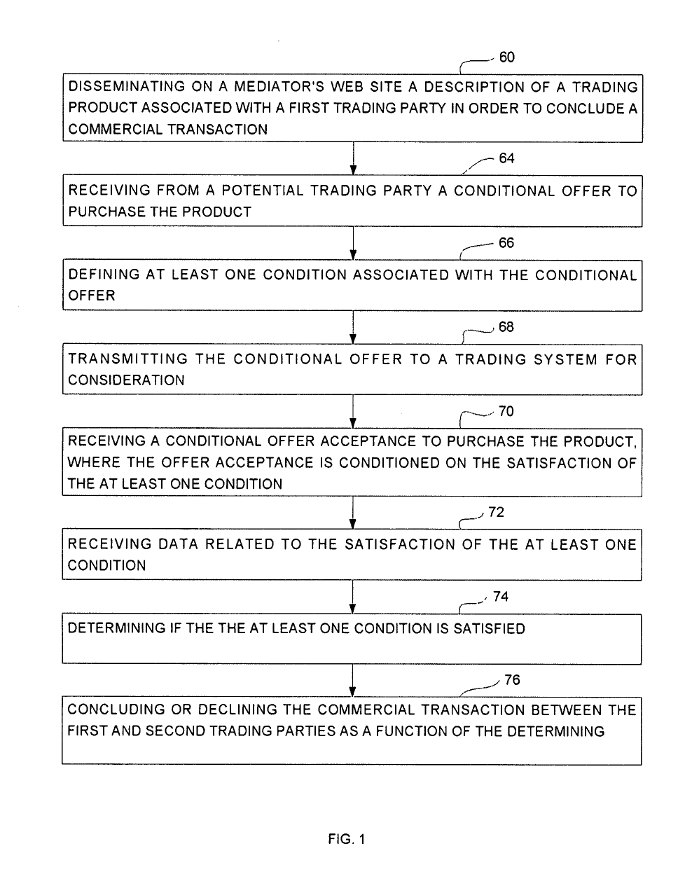

Referring to FIG. 1, there is provided a method for concluding an electronic commercial transaction based on a conditional offer, where the offer is conditioned on the satisfaction of at least one condition. First, the mediator disseminates on its Web site a description of a product associated with a first trading party 60, where it is indicated that a second trading party can submit a conditional offer to purchase the product.

Then, the mediator receives from a second trading party a conditional offer to purchase the product 64. The mediator also receives at least one condition associated with the conditional offer, where the at least one condition can be defined by the first trading party, the second trading party or the mediator 66.

Once the conditional offer received, the latter is transmitted by the mediator to a trading system for consideration 68. The conditional offer can for instance be a bid offer, a barter offer or, simply, a purchase offer to buy the product. The trading system considers the conditional offer and processes it according to the trading system rules.

If the conditional offer is accepted, the trading system transmits a conditional offer acceptance to the mediator. The mediator receives the conditional offer acceptance 70 and data related to the satisfaction of the at least one condition which can be originated from a third party such as a carrier 72. Then the mediator determines, as a function of the received data, if the at least one condition is satisfied and concludes or declines the commercial transaction between the first trading party and the second trading party as a function of the determining 76. Finally, the mediator notifies the different parties of the conclusion of the commercial transaction.

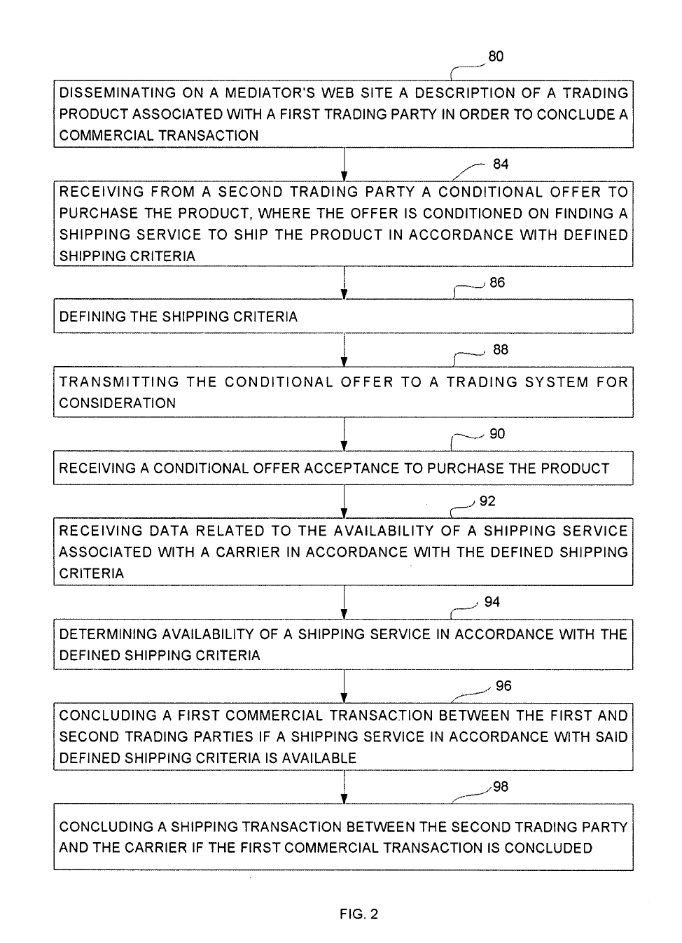

FIG. 2 illustrates a particular example of concluding a commercial transaction based on a conditional offer where the condition is related to finding an available shipping service in accordance with defined shipping criteria. According to this method, first, the mediator disseminates on its Web site a description of a trading product associated with a first trading party 80, where it is indicated that second trading parties can submit a conditional offer to purchase the product. Then, the mediator receives from a second trading party a conditional offer to purchase the product, where the offer is conditioned on finding a shipping service to ship the product in accordance with defined shipping criteria 84.

The next step is to define the shipping criteria which can be defined by the first trading party, the second trading party or the mediator 86. Once the conditional offer received, the latter is transmitted by the mediator to a trading system for consideration 88. As mentioned here above, the conditional offer can for instance be a bid offer, a barter offer or, simply, a purchase offer to buy the product. The trading system considers the conditional offer and processes it according to the trading system rules.

If the conditional offer is accepted, the trading system transmits a conditional offer acceptance to the mediator. The mediator receives the conditional offer acceptance 90 and data related to availability of a shipping service in accordance with the defined shipping criteria 92. This data can be originated from carriers indicating if they are willing to ship the purchased product according to the predefined shipping criteria. The data can also be originated from the first trading party indicating if they have found a carrier available to ship the purchased product according to the defined shipping criteria. The data can also be originated from the second trading party to indicate that he found a shipping service in accordance with the defined shipping criteria.

The shipping criteria can be for example an identity of a given carrier and a cost range to ship the product. In this case, the condition is satisfied if the defined given carrier accepts to ship the product for a price within the defined cost range. Otherwise, the condition is not satisfied and the commercial transaction will be declined.

After receiving the data, the mediator determines, as a function of the received data, an availability of a shipping service in accordance with the defined shipping criteria 94 and concludes a first commercial transaction between the first and the second trading parties in accordance with the offer if a shipping service in accordance with the defined shipping criteria is available 96. After concluding the first commercial transaction between the first and second trading parties, the mediator concludes a shipping transaction between the second trading party and the carrier to ship the product 98. Finally, the mediator notifies the different parties of the conclusion of the commercial transactions.

The above described methods are essentially carried out by a mediator server using a computer program stored therein. The mediator server comprises a Web site on which a description of the product is disseminated. The Web site allows for selecting an option for carrying out a conditional offer associated with the product.

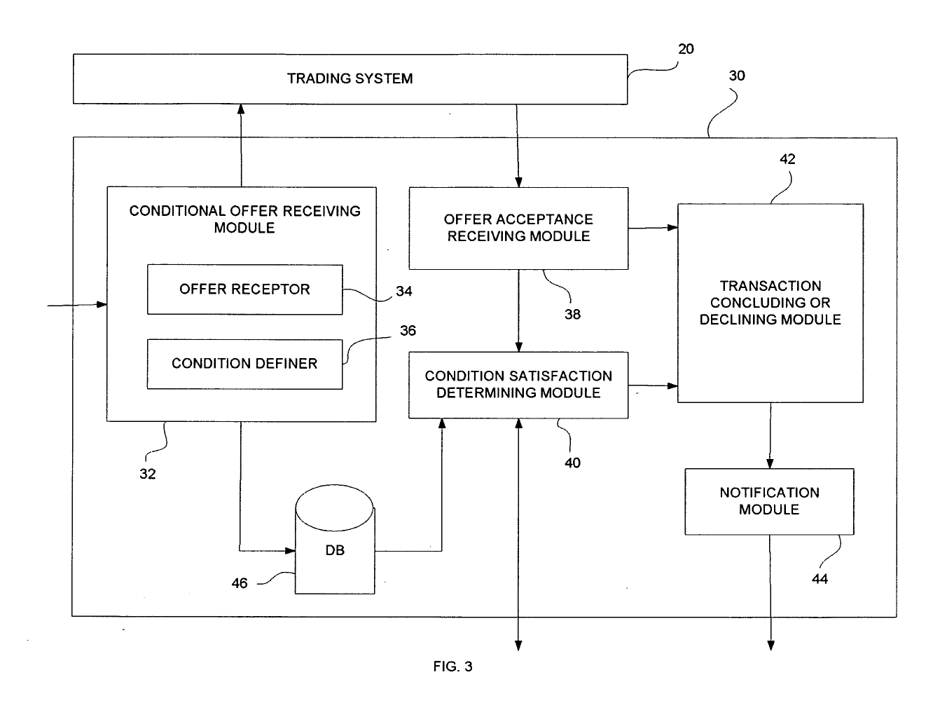

With reference to FIG. 3, there is provided a system for concluding an electronic commercial transaction based on a conditional offer 30. The system comprises a conditional offer receiving module 32, which comprises an offer receiver 34 and a condition definer 36, an offer acceptance receiving module 38, a condition satisfaction determining module 40, a transaction concluding or declining module 42, notification module 44 and a database 46.

The conditional offer receiving module receives, via the offer receptor, a conditional offer to purchase a product from a second trading party. Also, it receives the conditions on which the offer is conditioned via the condition definer 36. The conditions can be defined by the second trading party, from the seller or from a third party, such a carrier. The conditions are then stored in the database 46.

The conditional offer receiving module 32 transmits to a trading system 20 the conditional offer for consideration. The trading system processes the conditional offer according to the trading rules and, if the conditional offer is accepted, transmits a conditional offer acceptance to the offer acceptance receiving module 38. The offer acceptance receiving module 38 transmits a signal to the condition satisfaction determining module 40 and another signal to the transaction concluding or declining module 42 indicating the reception of the conditional offer acceptance.

The condition satisfaction module 40 extracts the defined stored conditions from the database 46 and investigates about the satisfaction of the defined conditions to determine if the conditions are satisfied. In order to do the investigation, the condition satisfaction determining module 40 is adapted to communicate with an external module or a third party (such as a carrier).

Once the condition satisfaction module 40 determines if the at least one condition is satisfied, it sends a signal indicating the result to the transaction concluding or declining module 42. If the at least one condition is satisfied, the transaction concluding or declining module 42 concludes a commercial transaction between the first trading party and the second trading party who desires to acquire the product. Otherwise, it declines the transaction. The notification module 44 notifies the different parties whether or not the transaction has been concluded. When the at least one condition is associated with a carrier to ship the product, the system can also comprise a shipping transaction concluding module for concluding a shipping transaction between the second trading party and the carrier if the commercial transaction is concluded between the first and second trading parties.

The system 30 is essentially provided by a mediator server having a mediator's Web site. The mediator server is connected to a network comprising the Internet for allowing trading parties to access the Web site to use the functionalities of the system. As above mentioned, the Web site disseminates a description of the product allows for selecting an option for carrying out a conditional offer associated with the product.

The system can comprise a listing module for receiving the description of the product and disseminating the description on the Web site, where the Web site is connected to an applet for selecting an option for carrying out a conditional offer associated with the product.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for concluding an electronic commercial transaction based on a conditional offer, the method comprising:
receiving a conditional offer associated with a trading product related to a first trading party, said conditional offer being originated from a second trading party;
receiving a conditional offer acceptance in response to said conditional offer, where said offer acceptance is conditioned on the satisfaction of at least one condition, said conditional offer acceptance being originated from said first trading party,
determining if said at least one condition is satisfied; and
concluding or declining said electronic commercial transaction between said first trading party and said second trading party as a function of said determining.

2. The method as claimed in claim 1, further comprising transmitting said conditional offer to a trading system for consideration, said conditional offer acceptance being transmitted by said trading system, and, after receiving said conditional offer acceptance, receiving data related to the satisfaction of said at least one condition, where said determining is carried out as a function of said received data and said at least one condition.

3. The method as claimed in claim 2, wherein said method is essentially carried out by a mediator server using a computer program stored therein.

4. The method as claimed in claim 3, wherein said mediator server is adapted to be connected to a network and said method is carried out electronically over said network.

5. The method as claimed in claim 1, wherein:
said at least one condition is finding a shipping service to ship said product in accordance with defined shipping criteria;
said determining consists of determining an availability of a shipping service in accordance with said defined shipping criteria; and
said concluding or declining said electronic commercial transaction between said first trad commercial transaction if otherwise.

6. The method as claimed in claim 5, wherein said electronic commercial transaction is concluded and said shipping service is associated with a given carrier, said method further comprising concluding a shipping transaction between one trading party among said first and second trading parties and said carrier to ship said product.

7. The method as claimed in claim 6, wherein said one trading party is said second trading party.

8. The method as claimed in claim 6, wherein said shipping criteria comprise at least one of an identity of a wanted carrier to ship said product and a cost range for shipping said product.

9. The method as claimed in claim 5, wherein said method is essentially carried out by a mediator server using a computer program stored therein.

10. The method as claimed in claim 9, wherein said mediator server is adapted to be connected to a network and said method is carried out electronically over said network.

11. The method as claimed in claim 9, wherein said mediator server comprises a Web site, said method further comprising disseminating on said mediator's Web site a description of said product and providing means for selecting, through said Web site, an option for carrying out a conditional offer associated with said product.

12. A system for concluding an electronic commercial transaction based on a conditional offer, the system comprising:
an offer acceptance receiving module for receiving a conditional offer acceptance associated with a trading product related to a first trading party, where said offer acceptance is conditioned on the satisfaction of at least one condition, said conditional offer acceptance being in response to a conditional offer originated from a second trading party, said conditional offer acceptance being originated from said first trading party;
a condition satisfaction determining module connected to said offer acceptance receiving module, where said condition satisfaction determining module receives said conditional offer acceptance and said at least one condition, receives data related to the satisfaction of said at least one condition, determines as a function of said received data and said at least one condition if said at least one condition is satisfied, and generates a condition satisfaction signal indicating if said at least one condition is satisfied; and
a transaction concluding module connected to said condition satisfaction determining module, where said transaction concluding module receives said conditional offer acceptance and said condition satisfaction signal and concludes or declines said electronic commercial transaction between said first trading party and said second trading party as a function of said received signal.

13. The system as claimed in claim 12 further comprising a conditional offer receiving module comprising an offer receptor for receiving said conditional offer and a condition definer for defining said at least one condition, where said conditional offer receiving module is connected to a trading system for transmitting said conditional offer thereto for consideration and connected to a database for storing said defined at least one condition therein, where said condition satisfaction determining module is connected to said database for receiving said at least one condition, and said offer acceptance receiving module is connected to said trading system for receiving said conditional offer acceptance associated with said conditional offer.

14. The system as claimed in claim 12, wherein said system is essentially provided by a mediator server.

15. The system as claimed in claim 14, wherein said mediator server comprises a Web site and is adapted to be connected to a network.

16. The system as claimed in claim 15 further comprising a listing module for receiving a description of said product and disseminating said description on said Web site, said Web site being connected to an applet for selecting an option for carrying out a conditional offer associated with said product.

17. The system as claimed in claim 12, wherein:
said at least one condition is finding a shipping service to ship said product in accordance with defined shipping criteria;
said determining consists of determining an availability of a shipping service in accordance with said defined shipping criteria; and
said concluding or declining said commercial transaction between said first trading party a transaction if otherwise.

18. The system as claimed in claim 17, wherein said electronic commercial transaction is concluded and said shipping service is associated with a given carrier, said system further comprising a shipping transaction concluding module for concluding a shipping transaction between said second trading party and said carrier to ship said product.

19. The system as claimed in claim 18, wherein said shipping criteria comprise at least one of an identity of a wanted carrier to ship said product and a cost range for shipping said product.

20. The system as claimed in claim 17, wherein said system is essentially provided by a mediator server.

21. The system as claimed in claim 20, wherein said mediator server comprises a Web site and is adapted to be connected to a network.
